(19) United States
(12) Patent Application Publication
(10) Pub. No.: US 2016/0207526 A1
(43) Pub. Date: Jul. 21, 2016

(54) VEHICLE-SIDE METHOD AND VEHICLE-SIDE DEVICE FOR DETECTING AND DISPLAYING PARKING SPACES FOR A VEHICLE

(71) Applicant: DAIMLER AG, Stuttgart (DE)

(72) Inventors: Stefan FRANZ, Ulm (DE); Joachim GLOGER, Bibertal (DE); Mathias HARTL, Filderstadt (DE); Lars KRUEGER, Ulm (DE); Matthias REICHMANN, Ostelsheim (DE)

(73) Assignee: Daimler AG, Stuttgart (DE)

(21) Appl. No.: 14/649,876

(22) PCT Filed: Oct. 30, 2013
(86) PCT No.: PCT/EP2013/003267

§ 371 Date: Jun. 4, 2015

(30) Foreign Application Priority Data
Dec. 5, 2012 (DE) 10 2012 023 706.5

(51) Int. Cl. B60W 30/06; B60R 1/00; H04N 7/18; G06K 9/00; G06T 11/60

(52) U.S. Cl. CPC B60W 30/06; G06K 9/00812; G06T 11/60; H04N 7/183; B60R 1/00; B60R 2300/806

(57) ABSTRACT

An on-vehicle method for detecting and displaying parking spaces for a vehicle is disclosed. An embodiment of the method includes detecting ambient data and measuring at least one parking space from the ambient data, detecting image sections of a surrounding of the vehicle at different points in time, assembling an overall image from the image sections detected at different points in time, generating a superimposed image by superimposing a representation corresponding to the at least one parking space onto the overall image, and displaying the superimposed image in the vehicle. An on-vehicle device for detecting and displaying parking spaces for a vehicle is also disclosed.

The invention relates to an on-vehicle method and an on-vehicle device to detect and display parking spaces for a vehicle.

A parking assistance system for a vehicle is known from DE 10 2008 049 113 A1 in which a parking space is detected using an ultrasound-based method and a detected parking space is superimposed onto an image of a rear-view camera. The superimposed image is, for example, displayed on a display of a central processing unit in the vehicle.

Based on this prior art, it is the object of the present invention to provide an on-vehicle method and an on-vehicle device being adapted to detect and display several parking spaces for a vehicle and to make them selectable for a user of a vehicle.

This object is solved by the measures indicated in the independent claims.

Further advantageous modifications of the present invention are the subject matter of the dependent claims.

According to a first aspect, an on-vehicle method for detecting and displaying parking spaces for a vehicle comprises detecting ambient data and measuring at least one parking space from the ambient data, detecting image sections of a surrounding of the vehicle at different points in time, composing an overall image from the image sections detected at different points in time, generating a superimposed image by superimposing a representation corresponding to the at least one parking space onto the overall image and displaying the superimposed image in the vehicle.

According to a modification, detecting and measuring of the at least one parking space is performed independently from detecting the image sections of a surrounding of the vehicle.

According to a further modification, detecting and measuring of the at least one parking space is performed based on ultrasound or based on radar.

According to a further modification, superimposing is performed such that a display of the superimposed image is metrically correct.

According to a further modification, superimposing is performed such that deviations from a drive of the vehicle straight ahead are compensated for when driving past a parking space.

According to a further modification, the image sections detected at different points in time are arranged in the superimposed image such that their position is proportional to a route covered by the vehicle.

According to a further modification, the method comprises selecting a parking space present in the superimposed image by a user and performing an automatic parking procedure into the selected parking space or assisting of a user to manually park into the selected parking space.

According to a further modification, the automatic parking is semi-automatic or fully automatic.

According to a further modification, selecting is performed by selecting an automatically generated target position or by manually positioning a target position in the superimposed image.

According to a second aspect, an on-vehicle device for detecting and displaying parking spaces for a vehicle comprises means present in a vehicle being adapted to perform the above method or its modifications.

The present invention is described in more detail below by describing embodiments with reference to the included drawing. In the enclosed drawing, the same or corresponding parts are denoted using the same reference signs consistently throughout the individual figures.

In the drawing:

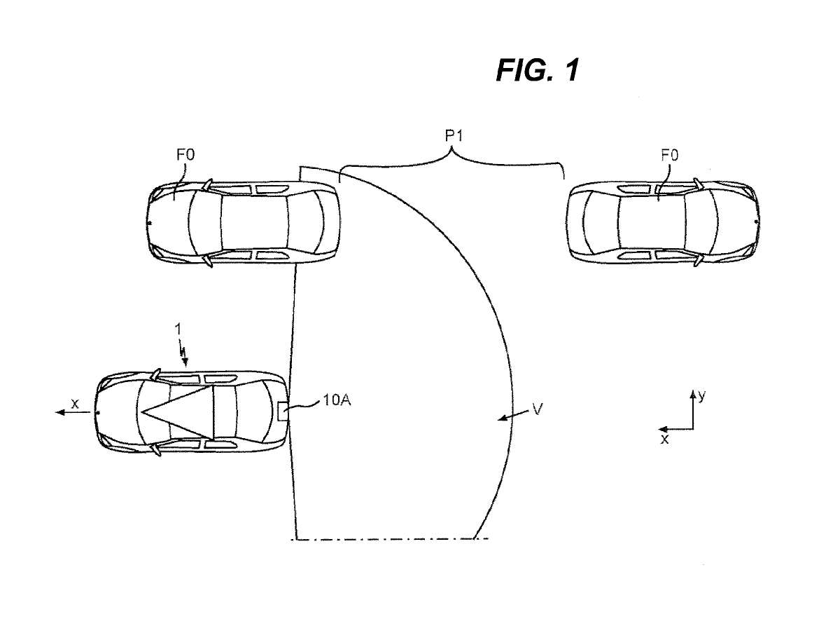

FIG. 1 is a schematic representation of a parking situation with a parallel parking space or curb-side parking space for a vehicle to be parked having a rear-view camera according to a first embodiment;

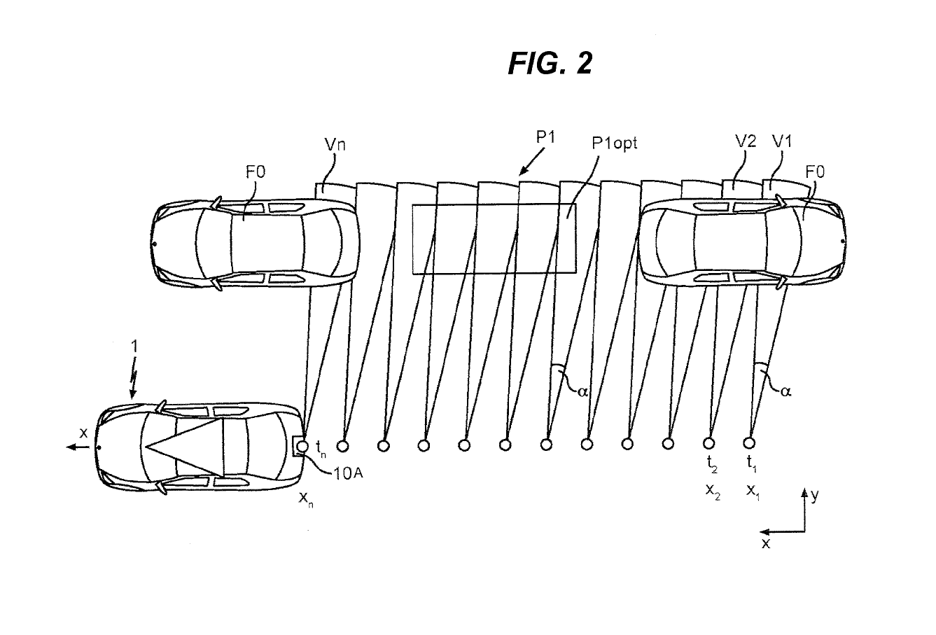

FIG. 2 is a further schematic representation of the parking situation with the parallel parking space for the vehicle to be parked having the rear-view camera according to the first embodiment;

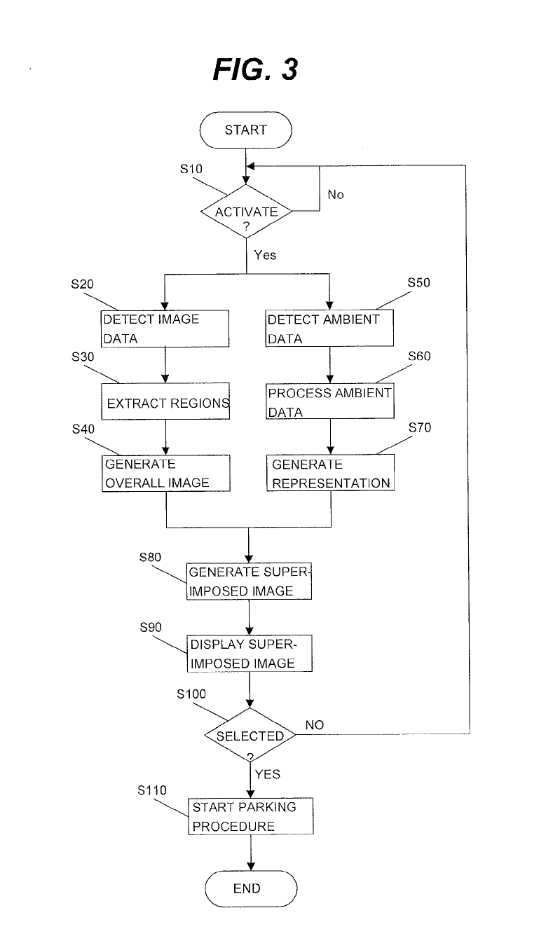

FIG. 3 is a flow chart of an on-vehicle method for detecting and displaying parking spaces according to the first embodiment;

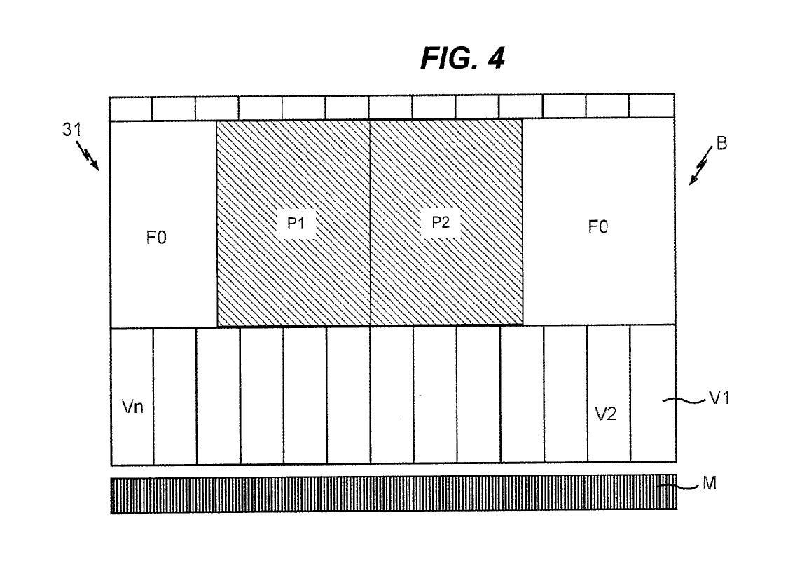

FIG. 4 is a schematic representation of a superimposed image on a display of a central processing unit in the vehicle to be parked according to the first embodiment.

In the following, a first embodiment will be described.

Referring to FIG. 1 and FIG. 2, the basic functionality of the first embodiment will be described.

FIG. 1 shows a schematic representation of a parking situation with a parallel parking space for a vehicle to be parked having a rear-view camera according to the first embodiment.

In FIG. 1, reference sign 1 denotes a vehicle to be parked, reference sign F0 denotes parked vehicles, reference sign P1 denotes a parallel parking space, reference sign 10A denotes a camera of the vehicle to be parked 1 and reference sign V denotes a receiving region of the camera 10A.

Camera 10A is, for example, a rear-view camera of the vehicle to be parked 1 or a camera in a side mirror of the vehicle to be parked 1. In general, any camera having a capturing region suitable for capturing images comprising positions of potential parking spaces can be used.

If the vehicle to be parked 1 is moved in the direction x shown in FIG. 1, a video stream is recorded by the camera 10A, which corresponds to several images recorded by the camera 10A at different points in time. At the same time, a position of the parking space P1 is detected and measured with an ambient sensor system. The ambient sensor system can, for example, be ultrasound-based or radar-based.

FIG. 2 shows a further schematic representation of the parking situation with the parallel parking space for the vehicle to be parked having the rear-view camera according to the first embodiment.

In FIG. 2, reference signs t₁, t₂, . . . , tₙ denote different points in time, reference signs x₁, x₂, . . . , xₙ denote different positions, reference signs V1, V2, . . . , Vn denote different image sections, reference sign a denotes an angle of a respective image section and reference sign P1 opt denotes an optimum parking position in parking space P1.

As is shown in FIG. 2, the camera 10A records different image sections V1, V2, . . . , Vn at different points in time t₁, t₂, . . . , tₙ and/or at different positions x₁, x₂, . . . , xₙ during driving of the vehicle 1 in direction x and composes the different image sections V1, V2, . . . , Vn into an overall image. In addition to recording of the different image sections V1, V2, . . . , Vn, the ambient sensor system continuously records data relevant to a surrounding of the vehicle to detect and measure the position of parking spaces P1.

On a display device in the vehicle 1, a superimposed image is displayed which is obtained by superimposing a representation corresponding to the detected parking spaces P1 onto the overall image, as is described in more detail below.

Referring to FIG. 3, the detailed functionality of the first embodiment will be described.

FIG. 3 shows a flow chart of an on-vehicle method for detecting and displaying parking spaces according to the first embodiment.

As shown in FIG. 3, in step S10 it is decided whether a processing to detect and display parking spaces P1 is activated. Activation can be dependent on certain conditions, such as, for example, a switched-on ignition of the vehicle 1, an engaged forward gear or an engaged forward driving stage of the vehicle 1, falling below a predetermined velocity threshold value, an expedient combination of one or all of these, and so on.

If a decision in step S10 is “NO”, processing returns to step S10. If the decision in step S10 is “YES”, processing proceeds to step S20 and in parallel to step S50.

In step S20, image data in the recording region V of the camera 10A are captured using the camera 10A. For capturing the image data, in the recording region V of the camera 10A, the camera 10A captures image data in a surrounding of the vehicle 1, as is shown in FIG. 1. In case of the rear-view camera shown in FIG. 1 as a camera 10A, a capturing angle of the camera 10A is approximately 180° with respect to a direction y in FIG. 1.

After step S20, the processing proceeds to step S30. In step S30, an image section is extracted from the captured image data. More exactly, a relevant image section is extracted from the image data captured in step S20, which is required to generate an overall image displaying a surrounding of the vehicle in which one or more potential parking spaces are present. As shown in FIG. 1, the image section preferably corresponds to a part of the capturing region V having an angle α. The angle α can be 5 to 45°, more preferably 10 to 30°, even more preferably 10 to 20° of the overall capturing region V with respect to the direction y in FIG. 1.

After step S30, the processing proceeds to step S40. In step S40, an overall image is generated from the extracted image section and image sections V1, V2, . . . , Vn obtained in previous passes of steps S20 and S30. The image sections V1, V2, . . . , Vn from respective passes can cover a narrow conical area, i.e. can be formed as a radar beam cone. The dimension or the capturing angle α of the image sections V1, V2, . . . , Vn can, for example, also be defined, depending on the driving velocity of the vehicle 1, such that the image sections V1, V2, . . . , Vn only partially overlap, in particular only in a section corresponding to y coordinates, in which parking spaces P1 are present.

The image sections V1, V2, . . . , Vn composed into the overall image can be captured in successive passes of steps S20 and S30, for example, at defined points in time t1, t2, . . . tn which have a predetermined time interval with respect to one another, or at defined positions x1, x2, . . . , xn of the vehicle 1, which have a predetermined distance interval to one another.

Steps S50 to S70 are performed in parallel to steps S20 to S40.

In step S50, ambient data are detected using the ambient sensor system. For example, ultrasound sensors can be used as ambient sensors which are adapted to detect distances of objects, such as, for example, parked vehicles F0, to the vehicle 1 and to output corresponding ambient data.

After step S50, the processing proceeds to step S60. In step S60, the ambient data are processed. Processing is performed such that ambient data detected in successive passes of step S50 are combined with one another. If the ambient data detected in successive passes of step S50 indicate that free space is present between the parked vehicles F0, as is shown in FIG. 1 and FIG. 2, which corresponds to a predetermined distance of the parked vehicles F0, which is sufficient to park the vehicle 1, the free space having this predetermined distance is determined as a parking space P1. If the free space is as large as that the vehicle 1 can be parked in several non-overlapping positions, several parking spaces P1 are determined in the free space. The determined parking spaces P1 are stored and are available for further processing. Additionally, other obstacles than the parked vehicles 1 can be detected using the ambient data.

After step S60, the processing proceeds to step S70. In step S70, a representation corresponding to the detected parking spaces P1 is generated from the processed environmental data.

After step S70, the processing proceeds to step S80. In step S80, a superimposed image is generated from the overall image obtained in step S40 and the representation obtained in step S70. The depicted superimposed image will be described with reference to FIG. 4.

FIG. 4 shows a schematic representation of the superimposed image on a display 31 of a central processing unit in the vehicle to be parked 1 according to the first embodiment.

As shown in FIG. 4 by hatched regions, in the superimposed image, for example, determined parking spaces P1 and P2 are displayed between the parked vehicles F0.

After step S80, the processing proceeds to step S90.

In step S90, the superimposed image obtained in step S80 is displayed on a display device in the vehicle 1. The overall image can be merged with the odometric or route data available in the vehicle 1 and/or ambient data of the determined parking spaces detected by the ambient sensor system and if necessary detected obstacles into the superimposed image such that the superimposed image is metrically correct. Additionally, deviations from a drive of the vehicle 1 straight ahead when passing the parking space, such as, for example, curved drives, which would result in undesired image effects in the superimposed image, can be compensated for.

In generating the superimposed image, different virtual projection objects can be used: a cylinder having a main axis along a driving trajectory of the vehicle 1, a prism having a main axis along the driving trajectory of the vehicle 1, sides on the base and as a virtual wall, a surface model with an obstacle next to the parking space as a near wall and no obstacle as a far wall. The image sections V1, V2, . . . , Vn are arranged in the overall image and correspondingly in the superimposed image such that a respective position of an image section is proportional to a route covered by the vehicle 1.

In case of the rear-view camera shown in FIG. 1 and FIG. 2 as a camera 10A, in step S30, image information is extracted as an image section from an outer edge region of a lens of the camera 10A. In this outer edge region, in case of large opening angles of the camera 10A, distortions and contortions of the image section are large. Therefore, a rectification, such as, for example, a cylinder projection, is be performed on the image section in order to reduce or to compensate for the distortions and contortions.

For a camera 10A provided in the side mirror, an image section is extracted from a central region of a lens of the camera 10A in which less of the surrounding is represented for each individual image element than in the case of the rear-view camera. In this case, by means of a driving route of the vehicle 1, a position can be selected in the overall image and data of the image section, if necessary scaled, can be copied into the overall image in step S40.

Additionally, a suitable scale can be indicated in the superimposed image shown in FIG. 4. This scale can, for example, be a representation of the vehicle 1 itself as a graphic, icon, arrow head, etc. or a length of a parking space and positions required to park, for which driving manoeuvres, such as, for example, turning a steering wheel of the vehicle 1, must be performed. Indication of such a scale can be dependent on a respective state of the vehicle 1, such as, for example, a selection of a path of the vehicle 1, and/or of previously driven manoeuvres, such as, for example, the vehicle 1 slowly driving forward, stopping, driving backwards. Likewise, a meter scale M can be overlaid onto the superimposed image for better understanding of a representation.

Furthermore, a width and/or a length of a parking space P1, P2 can be directly overlaid, for example by superimposing onto the parking spaces P1, P2. Thus it is clarified which parking space P1, P2 is optimal with respect to a width and/or length.

By projection onto a base displayed in the superimposed image, further information, such as, for example, a distance between the vehicle 1 and parked vehicles F0 and/or other obstacles can be displayed. This can, for example, be performed using a color coding.

The previously referred to information can likewise be displayed alternatively or additionally in a calculated top view onto the vehicle 1 and the surrounding.

After step S90, the processing proceeds to step S100. In step S100, it is decided whether one of the parking spaces displayed in the superimposed image has been selected. If a decision in step 100 is “NO”, the processing returns to step S10.

Selecting one of the parking spaces can be performed by manual selection by a user of the vehicle 1, for example by operating a control element 1, such as, for example, a push-turn control, or touching the display 31 formed as a touch screen of the processing unit of the vehicle 1, and so on. The selection can include a pure selection of an automatically generated target position, such as, for example, P1opt in FIG. 2, and/or a manual positioning of a target position in the superimposed image. Only positions are allowed which are achievable by the vehicle 1 in terms of driving dynamics, for example due to a turning circle, a vehicle size and/or a current vehicle position.

If the decision in step 100 is “YES”, the processing proceeds to step S110. In step S110, a parking procedure is started on the basis of the selected parking space.

The parking procedure can be an automatic parking procedure into the selected parking space or a procedure assisting a user to manually park in the selected parking space. In case of the automatic parking procedure, this can either be semi-automatic or fully automatic.

In case of assisting, in selecting the target positions it can be provided that the region is displayed which would be navigated by the vehicle 1 during driving to a marked target position, to allow the user of the vehicle 1 to avoid obstacles when selecting the target position.

Furthermore, in case of assisting after selecting the target position, optical, aural or haptic indications can, for example, be given to the user such as, for example, “now turn right”.

In the following, a second embodiment will be described.

It should be noted that the second embodiment is identical to the previously described first embodiment except for the modifications described below.

In the previously described first embodiment, in step S30, image sections V1, V2, . . . , Vn are extracted from the overall capturing region V of the camera 10A to generate the overall image from the extracted image sections V1, V2, . . . , Vn. According to the second embodiment, instead of extracting the image sections V1, V2, . . . , Vn, in step S30, a lens device is used to only capture image data of image sections V1, V2, . . . , Vn in step S20, and to generate the overall image from these captured image sections V1, V2, . . . , Vn in step S40. This means, in this case, step S30 is omitted.

More exactly, the image sections V1, V2, . . . , Vn can each comprise a narrow conical section, i.e. can be formed as a radar beam cone, and can be captured at several successive points in time t1, t2, . . . , tn. The dimension or the capturing angle α of the image sections V1, V2, . . . , Vn can, for example, also be determined depending on the driving velocity of the vehicle 1 such that the image section V1, V2, . . . , Vn only partially overlap, in particular only in one section according to y coordinates in which the parking spaces P1 are present. Hereby, data quantity to be processed can be kept low. In case that the user decides on a parking space P1, the capturing angle α can then be increased again and the camera device 10A can be used as a rear-view camera having a field of vision which is as wide as possible. In other words, the capturing angle α is variably adjustable, in particular by a lens device, which preferably communicates with a control unit of the camera device 10A and/or of the vehicle 1. The capturing angle α for capturing the image sections V1, V2, . . . , Vn preferably lies between 5 and 45 degrees, more preferably between 10 and 30 degrees, particularly preferably between 10 and 20 degrees. The capturing angle α for detecting the surrounding preferably lies between 45 and 180 degrees, more preferably between 135 and 180 degrees, particularly preferably between 145 and 175 degrees in a function as a rear-view camera in which a continuous capturing can be appropriate.

It should be noted that, although the camera in the previous embodiments is a rear-view camera of the vehicle to be parked, for example, a camera in a side mirror of the vehicle to be parked can also be used. In general, any camera can be used which has a capturing region which is adapted to capture images with positions of potential parking spaces. Furthermore, the possibility also exists to use several cameras, such as, for example, the cameras of a surround view system which captures a surrounding of the vehicle using the cameras and calculates a top view onto the vehicle from the captured surrounding, and, at the same time, to compose respective image sections of the several cameras into the overall image.

It should furthermore be noted that, although the previous embodiments describe an application for one or more parallel parking spaces, the present invention is also applicable to other types of parking spaces, for example bay parking spaces or diagonal parking spaces.

Likewise, it should be noted that the previously described on-vehicle method or the previously described on-vehicle device combined with selecting a determined parking space and starting the parking procedure are part of a parking assistance system of the vehicle 1 to perform an automatic, i.e. semi-automatic or fully automatic, parking procedure or to assist a user in a manual parking procedure.

Although the present invention has been described above by embodiments with reference to the enclosed drawing, it is understood that different modifications and changes can be carried out without departing from the scope of the present invention, as defined in the appended claims.

With regard to further advantages and features of the present invention, reference is expressly made to the disclosure of the drawing.

1.-10. (canceled)

11. An on-vehicle method for detecting and displaying parking spaces for a vehicle, comprising the steps of:
detecting ambient data and measuring at least one parking space from the ambient data;
detecting image sections of a surrounding of the vehicle at different points in time;
composing an overall image from the image sections detected at different points in time;
generating a superimposed image by superimposing a representation corresponding to the at least one parking space onto the overall image; and
displaying the superimposed image in the vehicle.

12. The method according to claim 11, wherein the detecting ambient data and the measuring at least one parking space is performed independently from the detecting image sections of a surrounding of the vehicle.

13. The method according to claim 11, wherein the detecting ambient data and the measuring at least one parking space is performed based on ultrasound or based on radar.

14. The method according to claim 11, wherein the superimposing is performed such that a display of the superimposed image is metrically correct.

15. The method according to claim 11, wherein the superimposing is performed such that deviations from a drive of the vehicle straight ahead are compensated for when driving past a parking space.

16. The method according to claim 11, wherein the image sections detected at different points in time are arranged in the superimposed image such that a respective position of the image sections is proportional to a route covered by the vehicle.

17. The method according to claim 11, further comprising the steps of:
selecting a parking space present in the superimposed image by a user; and
performing an automatic parking procedure into the selected parking space or assisting a user to manually park into the selected parking space.

18. The method according to claim 17, wherein the automatic parking procedure is semi-automatic or fully automatic.

19. The method according to claim 17, wherein the selecting is performed by selecting an automatically generated target position or by manual positioning a target position in the superimposed image.

20. An on-vehicle device for detecting and displaying parking spaces for a vehicle which performs the method according to claim 11.
